(19) United States
(12) Patent Application Publication
(10) Pub. No.: US 2016/0211043 A1
(43) Pub. Date: Jul. 21, 2016

(54) SYSTEMS AND METHODS FOR REGULATING ELECTRICAL POWER GENERATED FROM A DECAY OF RADIATION-EMITTING ISOTOPES

(71) Applicant: Idaho State University, Pocatello, ID (US)

(72) Inventor: Eric A. Burgett, Pocatello, ID (US)

(21) Appl. No.: 14/997,209

(22) Filed: Jan. 15, 2016

Related U.S. Application Data
(60) Provisional application No. 62/104,442, filed on Jan. 16, 2015.

(51) Int. Cl. G21H 1/10; G21D 7/04

(52) U.S. Cl. CPC G21H 1/103; G21D 7/04

(57) ABSTRACT

Systems and methods are presented for regulating electrical power generated from a decay of radiation-emitting isotopes. The systems include a diode formed of a semiconductor material capable of mitigating radiation damage by operating at temperatures greater than 300° C. In some embodiments, the semiconductor material includes uranium oxide, UO_{2±x}, where 0≦x≦0.5. The systems also include a fluid comprising an isotope emitting alpha particles. The systems additionally include a closed circuit having the fluid disposed therein and configured to bring the fluid in contact with the diode. The methods involve flowing a fluid across a surface of a diode and generating electrical power from the diode in response to radiation absorbed therein. The fluid includes an isotope that emits alpha particles. The surface of the diode defines a portion of a closed circuit in which the fluid flows. The methods additionally involve extracting, from the fluid, decay products of the isotope. Other systems and methods are presented.

### CROSS-REFERENCE TO RELATED APPLICATIONS

This application claims the benefit of U.S. Provisional Application No. 62/104,442, filed Jan. 16, 2015.

### FIELD

This disclosure relates generally to systems and methods for regulating electrical power generated from a decay of radiation-emitting isotopes.

### BACKGROUND

Nuclear isotopes offer energy densities virtually unmatched by chemical compounds and their related reaction processes. However, utilization of nuclear isotopes to generate electrical power involves managing radiation damage in materials containing (and proximate to) such isotopes. Traditional approaches to using nuclear isotopes have revolved around indirect conversion processes where energy from radiation is first converted to an intermediate energy form before subsequent conversion into electrical power. The intermediate energy form is most commonly thermal (e.g. heat), which is generated and stored within a material tolerant to radiation damage.

Indirect conversion processes, however, require additional equipment that can increase maintenance costs, decrease reliability, and introduce inefficiencies into an energy conversion process. Direct conversion processes are therefore highly sought after by the nuclear industry due to their simpler implementation and improved efficiencies. Devices for direct conversion processes typically incorporate semiconductor materials to absorb radiation and produce electrical power. These devices also incorporate a radiation source, which in conventional designs, commonly contains a non-replenishable quantity of nuclear isotopes.

To generate stable amounts of electrical power, direct conversion devices require non-varying fluences of radiation from the radiation source. However, as nuclear isotopes decay to produce radiation, their consumption yields a corresponding decrease in fluence from the radiation source. Applications which rely on direct-conversion devices must therefore account for a decrease in electrical power output with time, which is concomitant with the decrease in fluence. The power industry seeks systems that include direct conversion devices, but that provide more stable outputs of electrical power.

### SUMMARY

The embodiments described herein relate to systems and methods for regulating electrical power generated from decay of radiation-emitting isotopes. In one illustrative embodiment, a system for regulating electrical power from decay of radiation-emitting isotopes includes a diode formed of a semiconductor material capable of mitigating radiation damage by operating at temperatures greater than 300° C. In certain instances, the semiconductor material includes uranium oxide, UO_{2±x}, where 0≦x≦0.5. The system also includes a fluid comprising an isotope emitting alpha particles. The isotope may include 210-Po. The isotope may also be selected from the 227-Ac decay chain. The system additionally includes a closed circuit having the fluid disposed therein and configured to bring the fluid in contact with the diode.

In another illustrative embodiment, a method for regulating electrical power from a decay of radiation-emitting isotopes includes flowing a fluid across a surface of the diode. The fluid includes an isotope that emits alpha particles. The surface of the diode defines a portion of a closed circuit in which the fluid flows. The method also includes the step of generating electrical power from the diode in response to radiation absorbed therein. The method additionally includes extracting, from the fluid, decay products of the isotope. The isotope may include 210-Po. The isotope may also be selected from the 227-Ac decay chain. Other systems and methods are described.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 is a schematic diagram of a system for regulating electrical power generated from a decay of radiation-emitting isotopes; and

FIG. 2 is a perspective view of a diode for converting energy from radiation into electrical power, according to an illustrative embodiment.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

As used herein, the term “227-Ac decay chain” refers to isotopes along a decay path of highest probability (i.e., 227-Ac, 227-Th, 223-Ra, 219-Rn, 215-Po, 211-Pb, 211-Bi, 207-Tl, and 207-Pb) as well as isotopes along decay paths of lesser probability (i.e., 223-Fr, 219-At, 215-Bi, 215-At, 211-Po, 209-Pb, 209-Bi, and 205-Tl).

Conventional alpha-voltaic and beta-voltaic devices (i.e., direct conversion devices) output an electrical power that is directly proportional to an exponential decay of isotopes. For low-power devices, isotopes with long half-lives (e.g., 241-Am) can be utilized to extend the corresponding decay in electrical power over a large time period (e.g., decades). Low-power devices can therefore offer long operational lifetimes during which power output is effectively constant. However, to generate high power, isotopes with relatively short half-lives are required (e.g., 210-Po). High-power devices incorporating these isotopes compress the corresponding decay in electrical power into a short time period (e.g., days or years). Such compression lowers an operational life of these high-power devices and limits applications in which they may be deployed.

The embodiments described below include systems capable of extracting spent isotopes from a radiation source flowing proximate a direct conversion device. Such extraction maintains a high concentration of active isotopes in the radiation source, thereby maximizing its specific activity. As used herein, the specific activity refers to a number of decay events per mass of isotope, e.g., grams, within a unit of time, e.g., seconds. By regulating extraction of isotopes, the systems are capable of regulating electrical power generated by the direct conversion device. In some embodiments, the systems can be configured as small power sources (e.g., button-type cells) capable of replacing existing battery technologies.

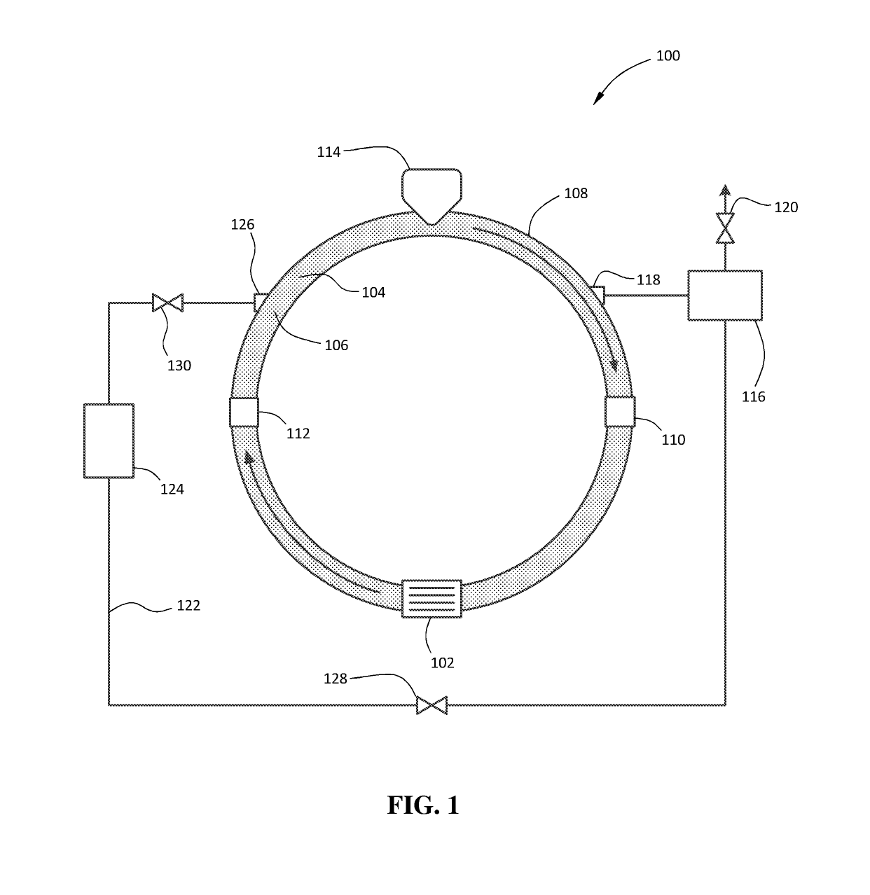

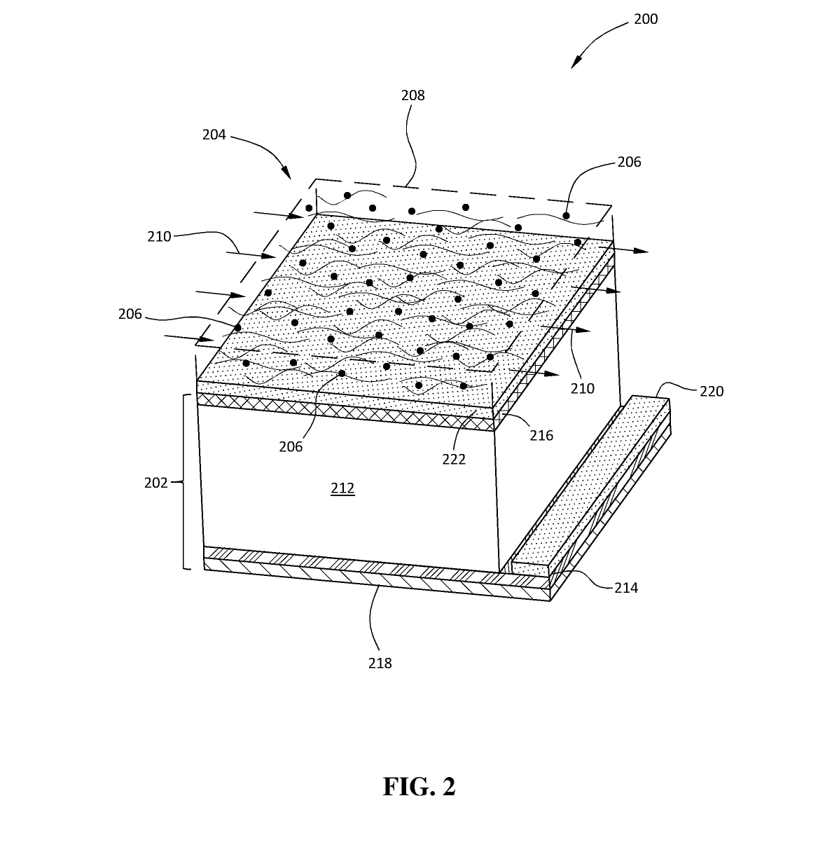

Referring now to FIG. 1, a schematic diagram is presented of a system 100 for regulating electrical power generated from a decay of radiation-emitting isotopes. The system 100 includes a diode 102 formed of a semiconductor material capable of mitigating radiation damage by operating at temperatures greater than 300° C. The diode 102 may include a plurality of diodes electrically-coupled in series, in parallel, or any combination thereof. For example, and without limitation, the diode 102 may include a pair of diodes in a sandwiched configuration (i.e., a “flip-chip” configuration). In another non-limiting example, the diode 102 may include a stacked sequence of diodes. Other configurations are possible. During operation, the diode 102 absorbs radiation within the semiconductor material to generate electrical power. Aspects of the diode 102 are described further in relation to FIG. 2.

The system 100 also includes a fluid 104 comprising an isotope 106 emitting alpha particles. The fluid 104 may be any combination of solid, liquid, and gas phases that allows flow. The fluid 104 may also exhibit a specific activity sufficient to heat the fluid 104, via self-irradiation, above a threshold temperature in which the fluid 104 includes no solid phase. In some embodiments, the system 100 may include a heater (not shown) thermally-coupled to the fluid 104. In these embodiments, the heater may serve as a primary source of heat for the fluid 104 or serve as an auxiliary source of heat that supplements self-irradiation of the fluid 104.

In some embodiments, the fluid 104 may be formed entirely of the isotope 106 (e.g., a molten body of 210-Po, a vapor of 219-Rn, etc.). In other embodiments, the isotope 106 is dispersed in the fluid 104, which serves as a carrier medium (e.g., micro- or nano-sized particles of isotope suspended in the fluid 104). In still other embodiments, the isotope 106 is dissolved in a liquid solvent. The liquid solvent may be a molten salt (e.g., halide salts) or a molten low-viscosity glass (e.g., a lithium silicate glass). Non-limiting examples of the liquid solvent include Na₂Po, PoCl₂, and PoPb alloy. Thermal energy may be required to allow the liquid solvent to enter (or maintain) a liquid state. In general, the fluid 104 may contain any concentration of isotopes therein, including concentrations of multiple isotopes. In some embodiments, a concentration of isotopes corresponds to a specific activity less than 200 GBq/g. In other embodiments, the concentration of isotope corresponds to a specific activity greater than 500 Gbq/g.

The system 100 additionally includes a closed circuit 108 having the fluid 104 disposed therein and configured to bring the fluid 104 in contact with the diode 102. In some embodiments, the diode 102 has a surface that defines a portion of the closed circuit 108. The surface may function as an interior surface of the closed circuit 108 that is exposed to the fluid 104. In some embodiments, such as that shown in FIG. 1, the closed circuit 108 is a closed-loop circuit configured to recirculate the fluid 104 repeatedly through the diode 102. In other embodiments, the closed circuit 108 is configured to flow the fluid 104 “once-through” the diode 102. In FIG. 1, the closed-circuit 108 is depicted as a closed-loop with the fluid 104 depicted as flowing in a clockwise direction. However, this depiction is for illustration only. In other embodiments, the fluid 104 may also flow counterclockwise. In still other embodiments, the closed circuit 108 may be in a linear configuration such that the fluid 104 flows along a single axis of direction.

In some embodiments, the system 100 includes a pump coupled to the closed circuit 108. As depicted in FIG. 1, the pump may include a plurality of pumps 110, 112 coupled to the closed circuit 108. The pump may be selected from any type of pump capable of displacing the fluid 104 through the closed circuit 108. Additional considerations may also govern a selection of the pump including chemical compatibility, thermal capability, radiation compatibility, and so forth. In some embodiments, the pump includes a magnetohydrodynamic pump. In these embodiments, the magnetohydrodynamic pump may be powered using electrical current from the system 100. During operation, the pump 110, 112 flows the fluid 104 through the closed circuit 108, which may include recirculating the fluid 104 through the closed circuit 108.

In FIG. 1, the pump 110, 112 is depicted as two pumps. A first pump 110 may be arranged on the closed circuit 108 to increase an entry pressure of fluid into the diode 102, and a second pump 112 may be arranged on the closed circuit 108 to decrease an exit pressure of fluid from the diode 102. Such “push-pull” configuration may help the fluid 104 overcome drag caused when contacting the diode 102. However, it will be appreciated that the depiction of FIG. 1 is not intended as limiting. Other numbers (e.g., one, two, or more) and arrangements of pumps are possible along the closed circuit 108.

The system 100 may optionally include an extraction unit 114 disposed along the closed-loop circuit 108 and configured to remove decay products of the isotope 108 from the fluid 104. Such removal may involve chemical processes (e.g., reaction to induce precipitation), thermal processes (e.g., distillation) or selective gasification (e.g., sublimation or boiling), or any combination thereof. Other removal processes and their combinations are possible (e.g., physical separation by filtering or sieving).

In some embodiments, the extraction unit 114 may solidify liquid phases out of the fluid 104, condense gas or vapor phases out of the fluid 104, or both. For example, and without limitation, the fluid 104 may be a combination of 210-Po and its 206-Pb decay product at a temperature above 254° C. (i.e., a temperature above which 210-Po is liquid). A surface contacted with the fluid 104 and held at a temperature between 254° C. and 327° C. (e.g., 260° C.) can solidify 206-Pb out of the fluid 104. (206-Pb is solid below 327° C.) In another non-limiting example, the fluid 104 may include a combination of 227-Th, one or more intermediate daughter isotopes, and a final decay product of 207-Pb. If the fluid 104 is maintained above 1750° C., where 227-Th is liquid, a surface contacted with a vapor portion of the fluid 104 will condense 207-Pb out of the fluid 104. 207-Pb boils above 1750° C. It will be appreciated that this boiling temperature can be lowered by decreasing ambient pressure over the fluid 104 (e.g., via a vacuum pump or other suitable technique).

In some embodiments, the extraction unit 114 includes a heat exchanger having a surface in contact with the fluid 104. The surface may have a micro- or nano-structured pattern thereon. The heat exchanger may be configured to hold the surface at a constant temperature when in contact with the fluid 104.

The system 100 may also optionally include a pressure regulator 116 in fluid communication with the closed circuit 108. Such fluid communication may occur through a first port 118 in the closed circuit 108. The pressure regulator 116 may have an exit valve 120 for discharging the fluid 104 from the system 100 (e.g., to a safety overflow subsystem).

In some embodiments, such as that shown in FIG. 1, the pressure regulator 116 is coupled to an auxiliary circuit 122 having a reservoir 124 disposed therealong. In these embodiments, the auxiliary circuit 122 extends from the pressure regulator 116 to a second port 126 on the closed circuit 108. The second port 126 is positioned downstream of the first port 118 on a side of the diode 102 opposite the first port 118. A first valve 128 may be disposed along the auxiliary circuit 122 between the pressure regulator 116 and the reservoir 124 to control an exchange of fluid therebetween. A second valve 130 may be disposed along the auxiliary circuit 122 between the reservoir 124 and the second port 126 to control an exchange of fluid between the reservoir 124 and the closed circuit 108.

During operation, components disposed along the auxiliary circuit 122 may function in combination to supply fluid to or withdraw fluid from the closed circuit 108. Such supply and withdrawal may be assisted by the pressure regulator 116, which may increase or decrease a pressure of the fluid 104 to accelerate fluid transfer into or out of the diode 102. The auxiliary circuit 122 and its associated components may therefore enable a rapid start-up and/or shutdown of the system 100. Rapid shutdowns may be beneficial to prevent unsafe operation of the system 100 or to address emergency situations.

In some embodiments, the system 100 further includes a counterflow heat exchanger (not shown) that thermally-couples the fluid 104 to a radiation shield. Counterflow heat exchangers have coolant that flows in a direction opposite to that of an inlet fluid. By using this counterflow, thermal energy can be efficiently exchanged between the coolant and the inlet fluid. Such efficient exchange may provide a maximum drop in temperature (i.e., cooling) for the inlet fluid. In further embodiments, the radiation shield is formed of lead. In these embodiments, a heat of fusion associated with the lead may allow additional heat to be absorbed (i.e., by melting). Such absorption may be beneficial if a cooling unit of the system 100 fails.

In some embodiments, the isotope 106 decays directly into a stable isotope. In other embodiments, the isotope 106 decays through a series of unstable daughter isotopes until a final stable isotope is reached. In still other embodiments, the isotope 106 includes a first portion of isotopes that decays directly into the stable isotope and a second portion of isotopes that decays through the series of unstable daughter isotopes until the final stable isotope is reached.

In some embodiments, the isotope 106 includes 210-Po. In some embodiments, the isotope 106 is selected from the 227-Ac decay chain. In further embodiments, 227-Th may be isolated from an initial fluid containing 227-Ac. For example, and without limitation, a charge of 227-Ac may be insulated such that self-irradiation induces the charge to form a molten mass. In some embodiments, a cold surface from a disk, rod, sphere, or the like—which may have micro- or nano-structured patterns thereon—is contacted with the molten mass and held at approximately 1100° C. In response, 227-Th solidifies on the cold surface. (The melting temperature of 227-Th, which is approximately 1750° C., is higher than that of 227-Ac, which is approximately 1050° C.) The cold surface is then removed from the molten mass and heated to induce the solidified 277-Th to melt. The molten 227-Th is subsequently collected in a container. It will be appreciated that other methods are possible for isolating 227-Th from the initial fluid. Moreover, other isotopes may be isolated from 227-Ac (i.e., other daughter isotopes from the 227-Ac decay chain).

In some embodiments, the semiconductor material includes uranium oxide, UO_{2±x}, where 0≦x≦0.5. In some embodiments, the semiconductor material may be a single-crystal of uranium oxide. In other embodiments, the semiconductor material may be polycrystalline or amorphous uranium oxide. In some embodiments, the semiconductor material is capable of mitigating radiation damage by operating at temperatures greater than 500° C. In further embodiments, the semiconductor material 104 is capable of mitigating radiation damage by operating at temperatures greater than 1000° C. In still further embodiments, the semiconductor material is capable of mitigating radiation damage by operating at temperatures between 300° C. and 2000° C.

In some embodiments, the system 100 is packaged in a container that meets Type B packaging requirements for transporting radioactive materials.

In operation, the system 100 transports the fluid 104 in the closed circuit 108 to and from the diode 102. The fluid 104 may enter (or maintain) a flowing state using thermal energy from self-irradiation, heat from an external source, or any combination thereof. For example, in embodiments where the fluid 104 includes 210-Po, the fluid 104 absorbs a portion of energy released by a decay of 210-Po (i.e., approximately 140 kW/kg of 210-Po). This portion represents thermal energy used to heat the fluid 104. The absorbed thermal energy is sufficient to melt 210-Po, which has a low melting temperature (i.e., 254° C.). However, in embodiments where the fluid 104 includes 227-Th, a corresponding melting temperature can be relatively high (227-Th melts at temperatures above approximately 1750° C.) Energy from a decay of 227-Th and its daughter isotopes is inadequate to convert the fluid 104 into a liquid phase. In these embodiments, the heater is used to supply additional thermal energy to melt the fluid 104.

The first pump 110 and the second pump 112 circulate the fluid 104 in the closed circuit 108 between the diode 102 and the extraction unit 114. As described previously, such circulation may be assisted by the auxiliary circuit 122 and components disposed therealong (i.e., the pressure regulator 116, the reservoir 124, etc.). While traversing the diode 102, the fluid 104 contacts a surface of the diode 102, which brings the isotope 106 in contact with or proximate to the diode 102. The surface may be held at a predetermined temperature (e.g., to prevent solidification on the diode 102). The diode 102 therefore receives a fluence of radiation (e.g., a fluence of alpha particles) as the fluid 106 passes across the surface of the diode 102. The fluence of radiation is converted into electrical energy by processes that are described in relation to FIG. 2.

At the extraction unit 114, spent isotopes can be removed from the fluid 104. In embodiments involving thermal processes, the extraction unit 114 may solidify liquid phases out of the fluid 104, condense gas or vapor phases out of the fluid 104, or both. The heat exchanger, if present, can collect spent isotopes on the surface in contact with the fluid 104. For example, low-melting isotopes of lead (e.g., 206-Pb, 207-Pb, 211-Pb) can be collected and removed from the fluid 104. It will be appreciated that circulation in the closed circuit 108 enables the system 100 to continuously harvest spent isotopes from the fluid 104. Such extraction can be regulated to control a specific activity of the fluid 104. Thus, by regulating extraction of spent isotopes, the system 100 controls the specific activity of the fluid 104, and hence, an amount of energy converted into electrical power by the diode 102.

The system 100 can be operated to maintain the specific activity of the fluid 104 at levels greater than 90% of an initial specific activity. The system 100 can therefore produce electrical power using high specific activities (i.e., greater than greater than 500 Gbq/g), but at conversion efficiencies associated with direct-conversion devices. Moreover, as described in relation to FIG. 2, the semiconductor material 104 can be annealed during operation to “heal” damage caused by absorbing radiation. This advantage allows the system 100 to offer longer operational lifetimes than those based on conventional alpha-voltaic and beta-voltaic devices.

Referring now to FIG. 2, a perspective view is presented of a diode 200 for converting energy from radiation into electrical power, according to an illustrative embodiment. The diode 200 is analogous to the diode 102 described in relation to FIG. 1. Non-limiting examples of radiation that can be converted by the diode 200 include alpha particles, beta particles, gamma rays, and combinations thereof. Such radiation may have energies greater than 10 eV (i.e., ionizing radiation). For example, and without limitation, the radiation may be an 5.407 MeV alpha particle from a 210-Po decay. In another example, the radiation may be a 1.418 MeV beta particle from a 207-Tl decay. Other forms of radiation and their energies are possible.

The diode 200 is formed of a semiconductor material 202 capable of mitigating radiation damage by operating at temperatures greater than 300° C. The semiconductor material 202 may be an amorphous semiconductor material, a polycrystalline semiconductor material, or a single-crystal semiconductor material, or combinations thereof. The semiconductor material 202 can be annealed at a temperature greater than 300° C. to regenerate a state substantially undamaged by radiation. The state substantially undamaged by radiation may correspond to a loss in conversion efficiency of the diode 200 no greater than 15% relative to a semiconductor material unexposed to radiation.

In further embodiments, the semiconductor material can be annealed at a temperature greater than 500° C., while in still further embodiments the semiconductor material can be annealed at a temperature greater than a 1000° C. In other embodiments, the semiconductor can be annealed at a temperature ranging from 300° C. to 2000° C. Such annealing, in some embodiments, may occur continuously or intermittently during operation of the diode 200 (i.e., when energy is being converted from radiation into electrical power). In other embodiments, such annealing may also occur during an offline time period when the diode 200 is not operating. Annealing prevents the diode 200 from degrading below a performance threshold as radiation is progressively absorbed within the semiconductor material 202.

In some embodiments, the semiconductor material 202 is capable of mitigating radiation damage by operating at temperatures greater than 500° C. In further embodiments, the semiconductor material 202 is capable of mitigating radiation damage by operating at temperatures greater than 1000° C. In other embodiments, the semiconductor material 202 is capable of mitigating radiation damage by operating at temperatures between 300° C. and 2000° C.

In some embodiments, the semiconductor material 202 includes an oxide semiconductor having a majority component that includes an actinide element. In these embodiments, the majority component is greater, by mole fraction, than a total amount of other elements, excluding oxygen. In further embodiments, the semiconductor material 202 includes uranium oxide, UO_{2±x}, where 0≦x≦0.5.

The diode 200 also includes a radiation source 204 comprising an isotope 206 emitting alpha particles. The radiation source 204 is analogous to the fluid 104 described in relation to FIG. 1. In some embodiments, the radiation source 204 further comprises an isotope emitting beta particles. In FIG. 2, the isotope 206 is depicted as being dispersed within a volume 208. However, this depiction is for purposes of illustration only. For example, and without limitation, the radiation source 204 may be formed entirely of the isotope (e.g., a molten fluid of 210-Po). In general, the radiation source 204 may contain any concentration of isotopes therein. In some embodiments, the concentration of isotopes corresponds to a specific activity less than 200 GBq/g. In other embodiments, the concentration of isotope corresponds to a specific activity greater than 500 Gbq/g.

In some embodiments, the radiation source 204 may be external to the semiconductor material 202, such as shown in FIG. 2. In other embodiments, the radiation source 204 may also reside, in whole or in part, within the semiconductor material 202. For example, and without limitation, the radiation source 204 may include embedded isotopes within the semiconductor material 202. Such embedded isotopes may involve a substitution of unstable isotopes for stable isotopes within the semiconductor material 202. Embedded isotopes may also involve an implantation of unstable isotopes in the semiconductor material 202. Other types of embedded isotopes are possible.

When external to the semiconductor material 202, the radiation source 204 is a fluid, which may be any combination of solid, liquid, and gas phases that allows flow. The radiation source 204 may be directly in contact with the diode 200 or proximate the diode 200 with a gap therebetween. In FIG. 2, the radiation source 204 is depicted as a fluid flowing through the volume 210. A motion of flow is indicated by arrows 210. The fluid is in contact with the diode 202.

It will be appreciated that the radiation source 204 can produce other forms of radiation in addition to alpha-particle radiation. These other forms of radiation can include beta particles, gamma rays, X-rays, neutrons, nuclear fragments from spontaneous fission, etc. For example, and without limitation, the radiation source 204 may comprise isotopes that emit beta particles. Such isotopes may be in addition to the isotope 206 (e.g., the one or more isotopes emitting beta radiation). Such isotopes may also be unstable daughter isotopes that result from a decay of the isotope 206. In another non-limiting example, beta particles absorbed within radiation source 204 or the semiconductor material 202 may produce X-ray radiation upon being decelerated (i.e., a bremsstrahlung secondary radiation).

In some embodiments, the isotope 206 can decay directly into a stable isotope. In other embodiments, the isotope 206 can decay through a series of unstable daughter isotopes until a final stable isotope is reached. In still other embodiments, the isotope 206 includes a first portion of isotopes that can decay directly into the stable isotope and a second portion of isotopes that can decay through the series of unstable daughter isotopes until the final stable isotope is reached.

Within the diode 200, the semiconductor material 202 exhibits doped regions that correspond to diode portions having a majority of charge carriers that are positively-charged (i.e., holes) or negatively-charged (i.e., electrons). The latter represent p-type diode portions and the former represent n-type diode portions. The semiconductor material 202 may also exhibit undoped regions that correspond to diode portions having charge carriers in equal proportions (i.e., substantially equal proportions of holes and electrons). Such undoped regions are often referred to by those skilled in the art as “intrinsic” and represent i-type diode portions.

Doped regions within the semiconductor material 202—whether corresponding to p-type diode portions or n-type diode portions—may be formed using any type of dopant and corresponding dopant distribution. Non-limiting examples of dopant distributions include uniform distributions and gradient distributions. Doped regions may be formed by substituting one element for another in the semiconductor material 202 or by altering its compositional stoichiometry. In some embodiments, p-type diode portions or n-type diode portions in the semiconductor material 202 are formed by varying oxygen stoichiometry, by substituting elements, or both. For example, and without limitation, the semiconductor material 202 may include uranium oxide, UO₂. A p-type region may be formed by substituting Y or La for U in predetermined amounts. Alternatively, an n-type region may be formed by lowering an oxygen stoichiometry to a predetermined under-stoichiometry, i.e., UO₂₋ₓ, where x represents the predetermined under-stoichiometry. It will be understood that dopants vary depending on a composition of the semiconductor material 202. As such, the example presented herein is not intended to limit the composition of semiconductor material 202 or its possible dopants.

The semiconductor material 202 may have any number and combination of junctions between p-type diode portions, n-type diode portions, and i-type diode portions in order to define a structure of the diode 200. For example, and without limitation, the diode 200 may exhibit a p-n structure, a p-i-n structure, an n-p-n structure, or a p-n-p structure. Other structures are possible. FIG. 2 depicts the diode 200 as having an i-type diode portion 212 sandwiched between a p-type diode portion 214 and an n-type diode portion 216 (i.e., the p-i-n structure). However, this depiction is for purposes of illustration only. In some embodiments, the diode 200 includes a p-n structure or a p-i-n structure.

It will be appreciated that the semiconductor material 202 exhibits a thermochemistry such that, when exposed to elevated temperatures (e.g., greater than 300° C.), the structure of the diode 200 is preserved. This aspect of the semiconductor material 202 allows the diode 200 to provide diode functionality at temperatures that simultaneously anneal the semiconductor material 202. Those skilled in the art can therefore select an operating temperature for the diode 200 that allows a conversion of radiation energy into electrical power, but at an output substantially unaffected by a cumulative exposure to radiation. The output may vary by no more than 15% when compared to an initial output produced by the diode before exposure to radiation.

A band-gap of the semiconductor material 202 may be selected by those skilled in the art to match the operating temperature of the diode 200, to establish a desired output voltage from the diode 200, or both. Such selection may include considerations of an annealing temperature for the semiconductor material 202. In some embodiments, the semiconductor material has a band gap ranging from 0.5 to 3.0 eV. In other embodiments, the semiconductor material 202 has a band gap ranging from 3.0 to 6.0 eV. In still other embodiments, the semiconductor material 202 has a band gap ranging from 6.0 to 12.0 eV. Values for the aforementioned band gaps are referenced to room temperature (i.e., 300 K) and may be direct band gaps or indirect band gaps.

The bandgap of the semiconductor material 202 can be “tuned” (i.e., selected) by alloying of a base material in the semiconductor material 202 with another material. For example, and without limitation, the semiconductor material 202 may include uranium oxide as a base material. In certain instances, the base material of uranium oxide can be alloyed with a yttrium oxide material, a bismuth oxide material, a copper oxide material, a strontium oxide material, a calcium oxide material, or any combination thereof, to decrease the band gap. In other instances, the base material of uranium oxide can be alloyed with a silicon oxide material, an aluminum oxide material, a beryllium oxide material, or any combination thereof, to increase the band gap. In still other instances, the base material of uranium oxide can be doped with a thorium oxide material, a lanthanum oxide material, a lutetium oxide material, or any combinations thereof, to increase the band gap.

The semiconductor material 202 may also have a thermal conductivity greater than 1 W/(m·K), as measured at 20° C. This range of thermal conductivity may improve a temperature uniformity of the diode 200 during operation, thereby inhibiting a formation of “hot spots” or “cold spots”. “Hot spots” may induce premature failure of the diode 102, while “cold spots” may induce undesired solidification of the radiation source 204, which is a fluid. Improved annealing of the semiconductor material 202 may also result within this range of thermal conductivity. In some embodiments, the semiconductor material has a thermal conductivity between 1-100 W/(m·K), as measured at 20° C.

In some embodiments, the diode 200 includes a substrate 218. In these embodiments, the substrate 218 serves as a support, which may include support during fabrication of the diode 200. The substrate 218 may allow a growth of p-type diode portions, n-type diode portions, and i-type diode portions thereon, including a cumulative growth of such portions (e.g., to form stacks of diode portions). Growth of diode portions may involve deposition processes such as chemical vapor deposition (CVD), plasma-enhanced chemical vapor deposition (PECVD), metal organic chemical vapor deposition (MOCVD), molecular beam epitaxy (MBE), physical vapor deposition (PVD), pulsed laser deposition (PLD), evaporative deposition, and sputtering. Other deposition processes are possible.

In further embodiments, the substrate 218 is formed of the semiconductor material 202. In such embodiments, the substrate 218 may be amorphous, polycrystalline, or single crystal. The substrate 218 may have any type of electronic conductivity, including p-type electronic conductivity, n-type electronic conductivity, and i-type electronic conductivity. In FIG. 2, the substrate 218 is depicted in contact with the p-type diode portion 214, and in this instance, exhibits p-type electronic conductivity. However, this depiction is not intended as limiting. Other configurations are possible for the substrate 218. In some instances, the substrate 218 may serve as the i-type diode portion 212, the p-type diode portion 214, or the n-type diode portion 216.

In some embodiments, the diode 200 includes a connector 220, 222 coupled to the diode 200 and formed of an electrically-conductive material stable to at least 300° C. Such stability includes chemical stability to the semiconductor material 202. The connector 220, 222, may be coupled to the p-type diode portion 214 or the n-type diode portion 216. In FIG. 2, the diode 200 is depicted as having two contacts, i.e., a first contact 220 coupled to the p-type diode portion 214 and a second contact 222 coupled to the n-type diode portion 216. However, this depiction is not intended as limiting. Other contact configurations and geometries are possible.

Non-limiting examples of the electrically-conductive material include metals comprising Al, Ti, Au, Mo, Ta, W, Re, Os, Ir, and Pt. The electrically-conductive material may also be an electrically-conductive ceramic such as ZnO:Ga, Ga₂O₃:Zn, In₂O₃:Sn, and GaN. In some embodiments, the electrically-conductive material is stable to at least 1200° C. In other embodiments, the electrically-conductive material is stable up to 2000° C. The connector 220, 222 may vary in composition depending upon whether its coupling is to the p-type diode portion 214 or to the n-type diode portion 216. This variation may improve chemical stability, carrier collection efficiency, or both.

In some embodiments, the radiation source 204 may contact the diode 200 at a surface of the connector 220, 222, as shown in FIG. 2 for the second connector 222. In these embodiments, the radiation source 204 may be electrically conductive. Such electrical conductivity may be greater than 1.0×10⁵ S/m at 20° C. For example, and without limitation, the radiation source 204 may be an electrically-conductive fluid, such as a molten body of 210-Po. When electrically-conductive and in contact with the connector 220, 222, the radiation source 204 may function as part of the connector 220, 222. However, in certain instances, the radiation source 204 may replace the connector 220, 222 entirely (i.e., the radiation source 204 may contact the p-type diode portion 214 or the n-type diode portion 216 directly).

In operation, the diode 200 converts energy from radiation into electrical power. The radiation source 204 supplies radiation that is received by the diode 200. In embodiments having embedded isotopes, some or all of this radiation may originate within the semiconductor material 202. Radiation is produced by a decay of isotopes associated with the radiation source 204, which includes the isotope 206. During decay, the isotope 206 emits an alpha-particle. Depending on a mass number, the isotope 206 may decay directly into a stable isotope, decay through the series of unstable daughter isotopes until a final stable isotope is reached, or both. In general, radiation from the radiation source 204 may include alpha-particles, beta particles, gamma rays, and combinations thereof. Other types of radiation may be possible. Beta particles, if emitted, may decay under deceleration to further produce X-rays (i.e., bremsstrahlung secondary radiation).

Radiation from the radiation source 204 is absorbed within the diode 200, which may involve any diode portion therein. An availability of diode portions depends on the structure of the diode 200. Those skilled in the art may apportion a diode volume among available diode portions to bias radiation absorption within one or more particular portions. In FIG. 2, the i-type diode portion 212 occupies a greater volume than the p-type diode portion 214 or the n-type diode portion 216. This apportionment biases radiation absorption to the i-type diode portion 212. However, it will be understood that other structures and apportionments are possible.

Absorption of radiation within the diode 200 ionizes electrons to excited states within diode portions formed of the semiconductor material 202. Such ionization leaves empty states in an electronic band structure of the semiconductor material 202 that correspond to holes. Electrons and holes are ionized in pairs, with the former serving as negative charge carriers and the latter serving as positive charge carriers. Due to the structure of the diode 200, electrons and holes separate and accumulate on opposite sides of the diode 200. In the diode 200 of FIG. 2, such separation involves charge carrier motion from the i-type diode portion 212 to the p-type diode portion 214, where electrons accumulate, and to the n-type diode portion 216, where holes accumulate. Accumulation of electrons and holes on opposite sides of the diode 200 creates an electric field therein.

The electrical field induces a voltage potential between the first connector 220 and the second connector 222. In embodiments where the radiation source 204 is electrically-conductive, the radiation source 204 may serve part of or replace the connector 220, 222. The first connector 220 and the second connector 222 may be coupled to an electrical circuit to allow the voltage potential to drive an electric current.

The electric current represents a flow of electrons from the p-type diode portion 214, through the electrical circuit, and to the n-type diode portion 216. The first connector 220 collects electrons accumulated in the p-type diode portion 214 and transfers the collected electrons to the electrical circuit. The second connector 222 receives electrons from the electrical circuit and delivers the received electrons into the n-type diode portion 216, where the delivered electrons neutralize holes accumulated therein. Thus, the diode 200 can function analogously to a battery and supply electrical power to the electrical circuit. The electrical circuit may have any type, number, and combination of electrical-power consuming devices. The electrical power circuit may also include power inverters to convert DC electrical power from the diode 200 to AC electrical power. Other devices are possible in the electric circuit.

In some embodiments, the diode 200 is a plurality of diodes electrically-coupled in series, in parallel, or any combination thereof. In these embodiments, the radiation source 204 is shared in common among the plurality of diodes. The plurality of diodes may enable those skilled in the art to engineer the diode 200 to supply predetermined magnitudes of voltage, electrical current, or both. Moreover, the plurality of diodes may be electrically-coupled to one or more power inverters in order to supply AC electrical power. For example, and without limitation, the plurality of diodes can be electrically-coupled to one or more power inverters to supply 480 kVA.

Radiation absorption within the diode 200 involves a penetration of radiation into the semiconductor material 202, which includes alpha particles. Such penetration may displace atoms within the semiconductor material 202, generating defects that correspond to radiation damage. Non-limiting examples of defects include vacancy defects, interstitial defects, cluster defects, ionization-track defects, and threading defects. Other defects are possible. Penetration of alpha particles, in particular, may damage the semiconductor material 202 by depositing helium nuclei therein, which become entrapped. (Alpha particles correspond to helium nuclei.) Entrapped helium nuclei can passivate the semiconductor material 202, especially at junctions between diode portions. Such passivation stems from cluster defects created by the entrapped helium nuclei, which may also involve displaced dopants. In general, defects from radiation damage can cause a premature recombination of electron-hole pairs, degrading a performance of the diode 200.

To mitigate radiation damage, the operating temperature of the diode 200 may be altered to anneal the semiconductor material 202. Such annealing generates thermal energy sufficient to “heal” the semiconductor material 202. At the annealing temperature, a free energy of the semiconductor material 202 is such that a presence of defects is energetically unfavorable. Annealing also establishes thermal energies sufficient to diffuse entrapped helium nuclei out of the semiconductor material 202. Thus, by operating the diode 200 at an annealing temperature above 300° C., the semiconductor material 202 can regenerate a state substantially undamaged by radiation. Such operation may be continuous during electrical power generation, intermittent during electrical power generation, or during periods when the diode 200 is offline. This operational advantage is not found in conventional alpha-voltaic and beta-voltaic nuclear batteries, which are not designed to tolerate temperatures higher than 300° C.

The operating temperature of the diode 200 may be altered by controlling heat flow into the diode 200. Heat flow into the diode 200 may involve heat generated by absorbing radiation within the semiconductor material 202. Heat flow into the diode 200 may also involve conductive, convective, or radiative heat supplied by the radiation source 204 (i.e., when external to the diode 200). In embodiments having embedded isotopes, heat may be generated within the semiconductor material 202 by internal irradiation.

The operating temperature of the diode 200 may also be altered by controlling heat flow out of the diode 200. Heat flow out of the diode 200 may involve a heat sink thermally-coupled to the diode 200. A radiation shield may be thermally-coupled to the heat sink to provide additional surface area for heat transfer to an ambient environment. In some embodiments, the radiation shield is formed of a metal having a melting temperature below 500° C., such as lead or bismuth. In such embodiments, the metal provides a heat of fusion that, during melting, absorbs additional heat. This absorption of additional heat may be beneficial if a cooling unit of the diode 200 fails. Heat flow out of the diode 200 may also involve a heat exchanger thermally-coupled to the diode 200. In some embodiments, heat flow out of the diode 200 may involve conductive, convective, or radiative heat delivered to the radiation source 204 (i.e., external to the diode 200).

By manipulating heat flows into and out of the diode 200—including heat generated within the diode 200—the operating temperature can be increased, decreased, or held stable. It will be appreciated that the radiation source 204 may be selected to produce a fluence rate of radiation sufficient to anneal the semiconductor material 202 while enabling high outputs of electrical power (i.e., greater than 0.1 kW per gram of radiation source). This advantage stems from a tolerance of the semiconductor material to temperatures greater than 300° C. In addition to “healing” radiation damage, at annealing temperatures the semiconductor material 202 retains the p-type diode portions, n-type diode portions, i-type diode portions (if present) necessary for operation of the diode 200.

It will be appreciated that, during decay, an isotope may emit radiation in any direction. If a pathway of the emitted radiation fails to intersect the diode 200, energy associated with this decay event is lost, reducing a conversion efficiency of the diode 200. In some embodiments, the diode 200 includes a trench pattern disposed along a surface thereof. In these embodiments, the trench pattern allows the diode 200 to present a greater solid angle of capture to the radiation source 204. The greater solid angle of capture increases a probability of absorbing radiation within the semiconductor material 202. The trench pattern may have any type of pattern capable of forming channels within the diode 102. In some instances, the trench pattern includes a parallel array of channels. Non-limiting examples of the parallel array of channels include a parallel array of sinusoidal channels, a parallel array of triangular-wave channels, and a parallel array of square-wave channels. Other types of parallel arrays are possible.

According to an illustrative embodiment, a method for regulating electrical power from a decay of radiation-emitting isotopes includes flowing a fluid across a surface a diode. The fluid includes at least one isotope that emits alpha particles. The surface of the diode defines a portion of a closed circuit in which the fluid flows. The method also includes generating electrical power from the diode in response to radiation absorbed therein. The method additionally includes extracting, from the fluid, one or more decay products of the isotope. In some embodiments, during extraction a portion of the decay products may be removed, while in other embodiments, all of the decay products may be removed.

In some embodiments, the diode is formed of a semiconductor material capable of mitigating radiation damage by operating at temperatures greater than 300° C. In further embodiments, the semiconductor material 104 is capable of mitigating radiation damage by operating at temperatures greater than 500° C. In yet further embodiments, the semiconductor material 104 is capable of mitigating radiation damage by operating at temperatures greater than 1000° C. In other embodiments, the semiconductor material 104 is capable of mitigating radiation damage by operating at temperatures between 200° C. and 2000° C. In some embodiments, the semiconductor material includes uranium oxide, UO_{2±x}, where 0≦x≦0.5. In some embodiments, the isotope includes 210-Po. In some embodiments, the isotope is selected from the 227-Ac decay chain.

In some embodiments, extracting decay products occurs while flowing the fluid across the surface of the diode. In some embodiments, extracting decay products includes solidifying the decay products using an exposed surface of a heat exchanger. The exposed surface is in contact with the fluid and held below a melting temperature of the one or more decay products. The decay products may include an isotope of lead. In some embodiments, extracting decay products includes condensing the decay products using an exposed surface of a heat exchanger. The exposed surface is in contact with the fluid and held below a condensation temperature of the decay products. The exposed surface may be in contact with a gas or vapor phase within the fluid. The decay products may include an isotope of lead.

In some embodiments, the fluid exhibits no solid phase.

In some embodiments, the method further includes flowing molten 227-Ac across a collection surface to solidify 227-Th dissolved therein. The dissolved 227-Th is produced from a decay of 227-Ac in the molten 227-Ac. The collection surface is held below at a melting temperature of 227-Th. In these embodiments, the method also includes removing the solidified 227-Th from the collection surface and melting the solidified 227-Th to form the fluid.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A system for regulating electrical power generated from a decay of radiation-emitting isotopes, the system comprising:
a diode formed of a semiconductor material capable of mitigating radiation damage by operating at temperatures greater than 300° C.;
a fluid comprising an isotope emitting alpha particles; and
a closed circuit having the fluid disposed therein and configured to bring the fluid in contact with the diode.

2. The system of claim 1, further comprising a pump coupled to the closed circuit.

3. The system of claim 2, wherein the pump comprises a magnetohydrodynamic pump.

4. The system of claim 1, wherein the semiconductor material is capable of healing radiation damage by operating at temperatures greater than 500° C.

5. The system of claim 1, wherein the semiconductor material comprises uranium oxide, UO_{2±x}, where 0≦x≦0.5.

6. The system of claim 1, wherein the isotope comprises 210-Po.

7. The system of claim 1, wherein the isotope is selected from the 227-Ac decay chain.

8. The system of claim 1, further comprising an extraction unit disposed along the closed circuit and configured to remove decay products of the isotope from the fluid.

9. The system of claim 8, wherein the extraction unit comprises a heat exchanger having a surface in contact with the fluid.

10. The system of claim 1, the diode comprises a plurality of diodes electrically-coupled in series, in parallel, or any combination thereof.

11. The system of claim 1, further comprising a heater thermally-coupled to the fluid.

12. The system of claim 1, wherein the fluid has a specific activity sufficient to heat the fluid, via self-irradiation, above a threshold temperature in which the fluid comprises no solid phase.

13. The system of claim 1, further comprising a counterflow heat exchanger thermally-coupling the fluid to a radiation shield.

14. The system of claim 1, further comprising a pressure regulator in fluid communication with the closed circuit.

15. A method for regulating electrical power generated from a decay of radiation-emitting isotopes, the method comprising:
flowing a fluid across a surface of a diode, the fluid comprising an isotope that emits alpha particles;
generating electrical power from the diode in response to radiation absorbed therein;
extracting, from the fluid, decay products of the isotope; and
wherein the surface of the diode defines a portion of a closed circuit in which the fluid flows.

16. The method of claim 15, wherein the diode is formed of a semiconductor material capable of mitigating radiation damage by operating at temperatures greater than 300° C.

17. The method of claim 15, wherein extracting the decay products occurs while flowing the fluid across the surface of the diode.

18. The method of claim 15, wherein extracting the decay products comprises solidifying the decay products using an exposed surface of a heat exchanger, the exposed surface in contact with the fluid and held below a melting temperature of the decay products.

19. The method of claim 15, wherein extracting the decay products comprises condensing the decay products using an exposed surface of a heat exchanger, the exposed surface in contact with the fluid and held below a condensation temperature of the decay products.

20. The method of claim 15, further comprising:
flowing molten 227-Ac across a collection surface to solidify 227-Th dissolved therein, the collection surface held below at a melting temperature of 227-Th, the dissolved 227-Th produced from a decay of 227-Ac in the molten 227-Ac;
removing the solidified 227-Th from the collection surface; and
melting the solidified 227-Th to form the fluid.
